(19) United States
(12) Patent Application Publication
(10) Pub. No.: US 2010/0316204 A1
(43) Pub. Date: Dec. 16, 2010

(54) Methods and Systems for Optimizing Online Order Process Flow

(75) Inventors: Michael Loeb, New York, NY (US); Jon Jensen, New Canaan, CT (US); Edward McCabe, Yonkers, NY (US)

Correspondence Address: EDWARDS ANGELL PALMER & DODGE LLP, P.O. BOX 55874, BOSTON, MA, 02205, US

(73) Assignee: Loeb Enterprises, LLC

(21) Appl. No.: 12/814,267

(22) Filed: Jun. 11, 2010

Related U.S. Application Data
(60) Provisional application No. 61/186,301, filed on Jun. 11, 2009.

(51) Int. Cl. H04M 15/00

(52) U.S. Cl. 379/114.03

(57) ABSTRACT

A computer-implemented method for optimizing process flow of an online order. The method includes the steps of providing a client device displaying a user interface, presenting a consumer with an information page in the user interface requesting a set of information, including the phone number of the consumer; receiving first level information from the consumer, including the consumer's phone number, and determining whether the phone number is eligible for third-party local exchange carrier billing. When the phone number is eligible for third-party local exchange carrier billing, the consumer is presented with a credit card billing page. If no credit card information is received, the consumer is then presented with a phone billing page. When the phone number is not eligible for third-party local exchange carrier billing, the consumer is presented with a credit card billing page.

### CROSS REFERENCE TO RELATED APPLICATION

This application claims priority to U.S. Provisional Patent Application No. 61/186,301, filed Jun. 11, 2009, the disclosure of which is incorporated herein by reference in its entirety.

### BACKGROUND OF THE INVENTION

1. Field of the Invention

The present invention relates generally to the field of e-commerce and marketing, and more particularly to a system and method for optimizing order process flow using a web browser by generating and displaying dynamic transactional pages based on information entered by a consumer.

2. Description of the Related Art

Initially, payment options accepted by merchants for online transactions were limited to credit cards, such as Visa® and Mastercard®. As online commerce has expanded, additional payment options have become more widespread, including the use of debit cards and Automated Clearing House (ACH) billing as well as payment services such as PayPal®, BillMeLater®, and Google Checkout™. This expansion of payment options has allowed online merchants to process a greater number of transactions than was previously possible.

A merchant typically pays a service or processing fee to an acquiring bank when the merchant accepts a credit card as payment for goods or services. Most other common payment services also require the merchant to pay a fee for use of the service. Fees paid by merchants for accepting credit cards and other payment methods typically range from about one to about three percent of the total purchase price for the transaction. The service fees charged to merchants can have a significant effect on the merchant's bottom line, especially if the merchant has razor-thin profit margins or a high volume of transactions. Naturally, merchants seek to maximize the number of transactions while minimizing the cost of the transaction. It is therefore essential to take into account the transaction processing costs to make a well-informed decision as to which payment options to accept and how to present those options to a consumer during an order process.

Local phone bills have recently become a viable payment option for online merchants. For many years, local phone carriers have allowed third-parties to include charges for services in a consumer's local phone bill. In the past, third-party services eligible for billing through a local phone bill have generally been limited to telecommunications-related services. However, within the last few years, local carriers have begun to allow customers to charge a wide variety of different third-party services—many unrelated to telecommunications—to their local phone bills. This change has come about as a response to competitive pressure within the industry; it is an attempt to prevent current customers from switching to competing carriers. The rationale for this change is that once customers set up a recurring payment for a desired service on their local phone bills, the customers will be less likely to switch carriers to avoid the added hassle of dealing with several third-parties to change payment options. As a result, local phone companies have begun to allow to use a local phone bill as a viable payment device. Currently, all of these merchants must have a digital component to their service.

There are a number of drawbacks to billing third-party service through a local phone bill, and as a result, the marketplace has been slow to adopt this payment option. First, navigating the process for obtaining clearance to bill a third-party service on a local phone bill can be daunting and may require significant time and effort. Second, the fee charged to a third party for billing a service to a local phone bill is very high relative to the fee charged to a merchant for accepting a credit card or one of the other standard payment methods discussed above. Finally, the delay in receiving payment from a customer is also a significant drawback to billing a third-party service through a local phone bill. When a merchant uses a local phone bill to charge for a service, the merchant may not receive payment for that service for 90 days or more after the transaction occurs. In contrast, receipt of payment when accepting a credit card is nearly instantaneous. Because of these drawbacks, most merchants have opted not to pursue billing of their services through a local phone bill.

Despite the onerous process of become approved to accept payment, the amount of time it takes to receive payment, and other operational hurdles, there are still benefits in certain cases to accepting payment using a local phone bill. One such benefit is tapping into the market of consumers that still do not have credit cards. An additional benefit is immediacy and convenience. Local phone billing only requires a customer to remember his or her phone number. Most everyone can recite their phone number from memory. It is much less likely that a consumer has memorized his or her credit card number.

Consequently, there is a need for systems and methods of presenting online order information that captures the greatest number of transactions at the lowest possible cost, using a wide variety of payment options, including charging services to a local phone bill. Due to the large cost associated with billing to a local phone bill, an optimal order process will capture the maximum number of total transactions, while ensuring that the maximum subset of those transactions are billed to a credit card or other similarly priced method of payment and the remainder of the transactions are billed to a phone bill. The present invention provides such an order process.

### SUMMARY OF THE INVENTION

Advantages of the present invention are set forth in the brief description that follows. Additional advantages of the invention may be realized by the methods and systems particularly pointed out in the written description and claims, as well as from the appended drawings.

The invention includes a computer-implemented method for optimizing process flow of an online order. The method includes the steps of providing a client device displaying a user interface, presenting a consumer with an information page in the user interface requesting a set of information, including the phone number of the consumer; receiving first level information from the consumer, including the consumer's phone number, and determining whether the phone number is eligible for third party local exchange carrier billing. When the phone number is eligible for third party local exchange carrier billing, the consumer is presented with a phone billing option. When the phone number is not eligible for third-party local exchange carrier billing, the consumer is presented with a credit card billing page. In one exemplary embodiment, the phone number is a home phone number. But the phone number may be any number that is eligible for third-party local exchange carrier billing.

A system for optimizing process flow of an online order is also provided. The system includes a server having a processor and a memory, a database interfacing with the server, and a client device interfacing with the server and displaying a user interface. The user interface includes an information page configured to request a set of first level information, including the phone number of the consumer. The server is configured to determine whether the phone number is eligible for third party local exchange carrier billing, and is further configured to present the consumer with a credit card billing page and then a phone billing page if no credit card information is received from the consumer when the phone number is eligible for third-party local exchange carrier billing, and to present the consumer with a credit card billing page when the phone number is not eligible for third-party local exchange carrier billing.

The general description above and the following detailed description are exemplary and are intended to provide further explanation of the claimed invention. The accompanying drawings, which constitute part of this specification, are included to illustrate and provide a further understanding of the methods and systems of the invention. Together with the description, the drawings serve to explain principles of the invention.

### BRIEF DESCRIPTION OF THE DRAWINGS

So that those skilled in the art to which the subject invention pertains will readily understand how to implement the methods and systems of optimizing online order process flow without undue experimentation, preferred embodiments of the methods and systems will be described in detail below with reference to the following figures:

FIG. 1 is a schematic diagram of the system for optimizing online order process flow as described in the present disclosure;

FIG. 2 is flow chart depicting the process whereby a consumer progresses through a transactional path as described in the present disclosure;

FIG. 3 is a continuation of the flow chart of FIG. 2 depicting the process whereby a consumer progresses through a transactional path as described in the present disclosure;

FIG. 4 is an exemplary embodiment of a landing page displayed as part of the process described in the present disclosure;

FIG. 5 is an exemplary embodiment of a second level information page displayed after the landing page shown in FIG. 4;

FIG. 6 is an exemplary embodiment of an alternate second level information page displayed after the second level information page shown in FIG. 5, after it is determined that the consumer is not eligible to use third-party local exchange carrier billing as a payment option;

FIG. 7 is an exemplary embodiment of a credit card billing page that is shown to a consumer regardless of the consumer's eligibility for third-party local exchange carrier billing;

FIG. 8 is an exemplary embodiment of a credit card order confirmation page;

FIG. 9 is an exemplary embodiment of a phone billing order confirmation page;

FIG. 10 is a process flow diagram showing the path of a consumer who is not eligible for phone billing and who completes a transaction by credit card;

FIG. 11 is a process flow diagram showing the path of a consumer who is eligible for phone billing but opts to complete a transaction by credit card;

FIG. 12 is a process flow diagram showing the path of a consumer who is eligible for phone billing and opts to complete a transaction using phone billing rather than a credit card; and

FIG. 13 is a process flow diagram presenting each of the flow paths shown in FIGS. 10-12 in a single diagram.

### DETAILED DESCRIPTION OF THE PREFERRED EMBODIMENTS

The present invention provides methods and systems for optimizing an online purchase transactional path to maximize the total number of transactions, while ensuring that the largest possible subset of those transactions are effectuated using a credit card or similarly priced payment method, with the remainder of the transactions being effectuated using third-party billing to a local phone bill. In one exemplary embodiment, asynchronous technology, such as asynchronous JavaScript and XML (Ajax) is used to present a user with a number of dynamic pages in the required and optimal order for each individual consumer.

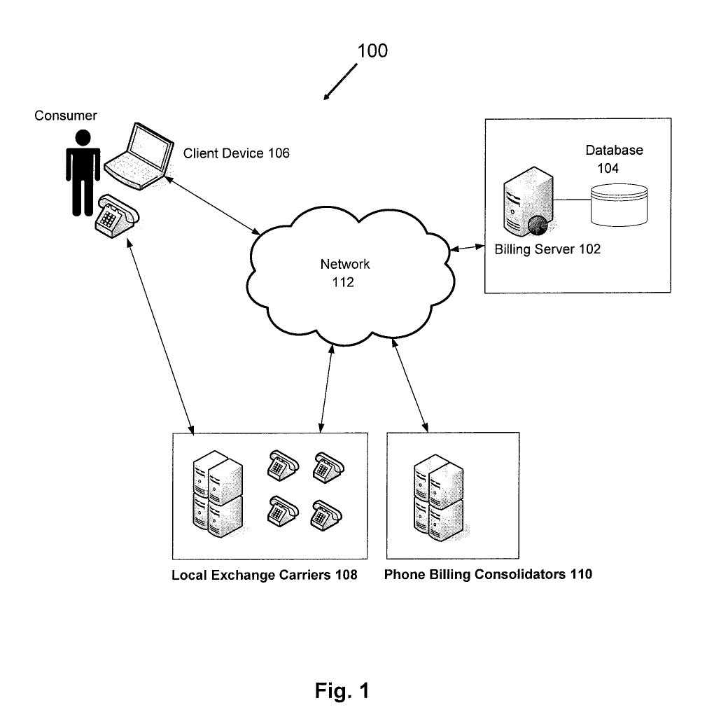

For purposes of explanation and illustration, and not limitation, an exemplary embodiment of a system in accordance with the present invention is shown in FIG. 1 and designated generally by the reference numeral 100. System 100 includes a billing server computer 102, a database 104, one or more client devices 106, a local exchange carrier 108 and a phone billing consolidator 110. Database 104, billing server 102, client devices 106, local exchange carrier 108, and billing consolidator 110 may interface with one another via a network 112. Network 112 may be any suitable network, including a company intranet or other local area network, a wide area network, and the Internet. Billing server 102 may include a plurality of servers, and database 104 may include a plurality of databases. Server 102 may interface directly with database 104 or may be connected to the database through network 112. Client devices 106 may include a computer, a mobile phone, or any other network-enabled device.

System 100 may comprise software components running on either billing management server 102 or clients 106. Billing management server 102 and clients 106 may run any suitable operating system and may include a variety of hardware configurations. Both billing management server 102 and clients 106 may include a processor coupled to a memory module and to a mass storage device via a bus or other communication medium; a display or other output device interfacing with the processor; and a keyboard, mouse, touchpad, or other input device that receives input from a user and interfaces with the processor. In one exemplary embodiment, clients 106 each include an input device for receiving user input and a display device for displaying content. The software implementing system 100 may include instructions written in a high level computer language and stored in a mass storage device. In one exemplary embodiment, a plurality of Ajax software components run on both billing management server 102 and client devices 106. These software components can be used to implement an application in a web browser that communicates with server 102 in the background, without interfering with the current rendering of the displayed web page.

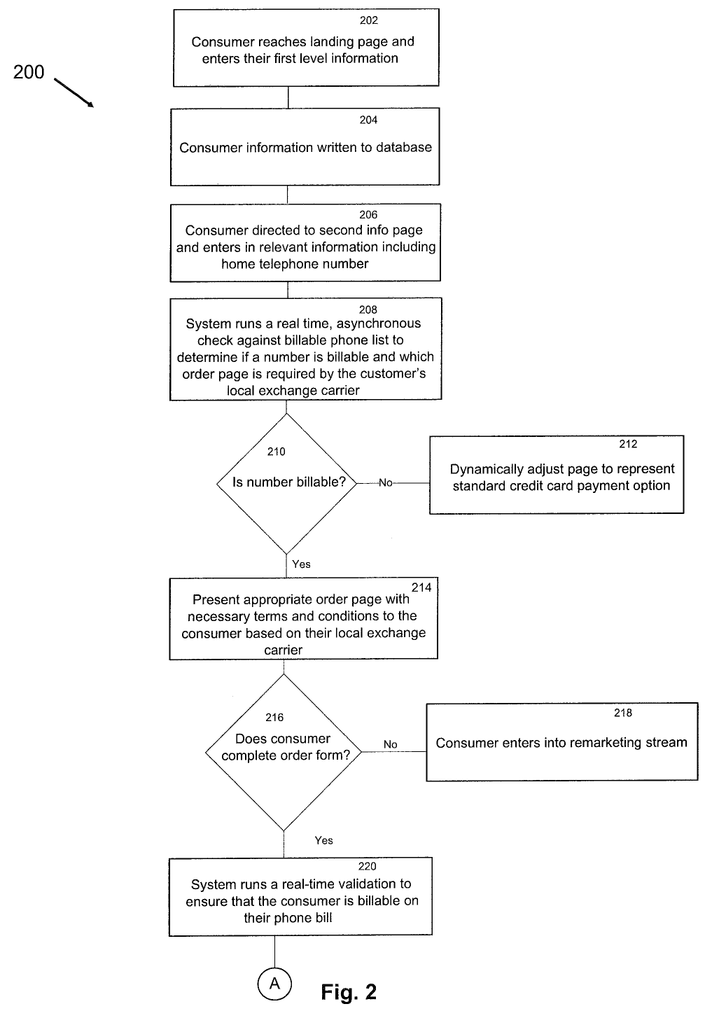

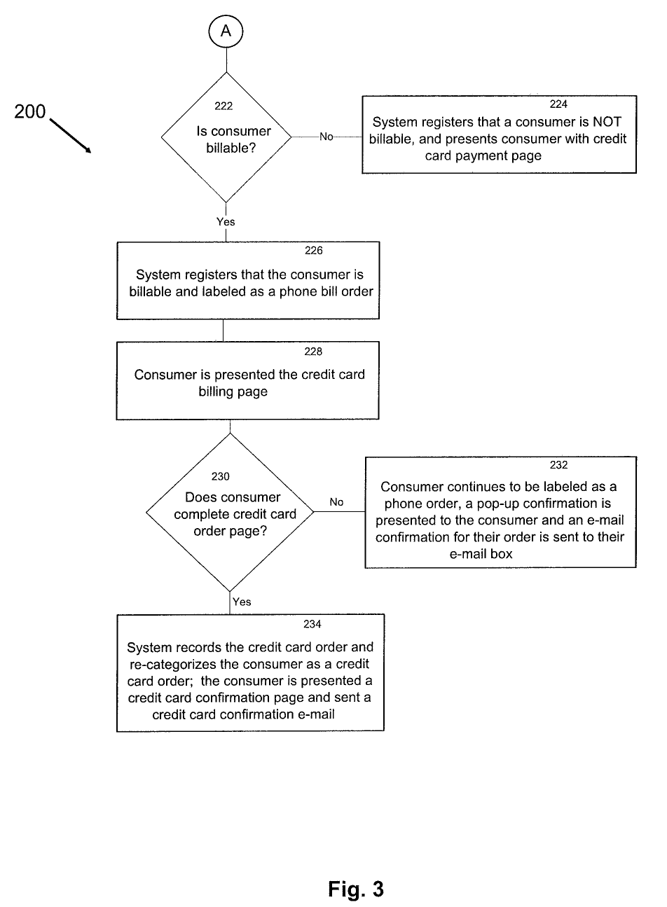

FIGS. 2 and 3 illustrate an exemplary embodiment of a method 200 for generating and displaying a dynamic order page on a web browser to optimize the number of transactions and minimize costs. Referring to FIG. 2, at step 202, a consumer accesses a landing page and enters the consumer's first level information. Landing page may be the first page that a consumer is shown after deciding to purchase an item from within the web browser. For example, the landing page could be the first page that a consumer sees after clicking a “checkout” button in an electronic shopping cart application.

First level information may include the consumer's first name, last name, and email address, although other information could be included as well. At step 204, the first level information received from the consumer is stored in database 104. First level information may be sent from the web browser running on client 106 to billing server 102 using Ajax or other asynchronous technology. Billing server 102 then writes the first level information to database 104. In one exemplary embodiment, the web browser does not send the information until the consumer clicks on or otherwise selects a “continue” or “send” button. In another exemplary embodiment, the information is sent as it is being entered by the consumer.

At step 206, the web browser displays a second page to the consumer requesting that the consumer provide second level information. Second level information may include, for example, name, address, city, country, state, postal code, phone number, and a security question and answer.

At step 208, billing server 102 runs a real-time, asynchronous check against a billable phone list housed within a database at phone billing consolidator 110 or other server to determine whether the phone number entered by the consumer is billable, that is, whether local exchange carrier 108 allows third-party billing on the consumer's local phone bill. In one exemplary embodiment, this check occurs immediately when the consumer fills out the phone number field. The list stored in the database may be a proprietary list of billable phone numbers used to determine if the consumer's local exchange carrier allows for such a transaction at a block level. In this context, a block level represents a block of phone numbers that have the same first seven digits. For example, the block of numbers beginning with 212-555-5XXX (where the Xs represent different number combinations) contains 1,000 possible numbers.

Step 210 is a decision step in which server 102 responds to the query from the web browser and indicates whether the entered phone number is billable. The web browser will then dynamically change the order page presented to the consumer based on the response from server 102. At step 212, if the block of numbers to which the consumer's phone number belongs is not billable, the web browser automatically adjusts the page to remove the disclosures and data fields required by the local exchange carriers for third-party billing, and to add fields for the consumer to input his or her credit card information. If billing server 102 determines that the consumer's phone number is not eligible for third-party billing, alternative payment options such as a credit card become the consumer's only option and the purchase transaction continues as it otherwise would without a phone billing option.

At step 214, if the block of numbers to which the consumer's phone number belongs is billable, the web browser does not remove any disclosures, fields or other visual objects from the page. It should be understood that in another embodiment, fields, disclosures or other visuals could be added at this step based upon the result of decision step 210.

At step 216, the consumer decides, based on the terms and conditions presented, whether to finalize the transaction and bill it to the consumer's local phone bill. At step 218, if the consumer elects not to continue with the transaction, the consumer's first level information, which was provided in step 202 and written to database 104, is saved and can be utilized to contact the consumer in the future for remarketing purposes. At step 220, if the consumer elects to continue with the transaction, billing server 102 runs a real-time check with phone billing consolidator 110 to determine if the consumer can use his or her local phone number as a method of payment. This real-time check of the consumer's individual number is distinct from the block-level check performed at step 208. This second check validates that the consumer's local exchange carrier 108 allows billing at the individual consumer level, rather than just at the block level.

Referring now to FIG. 3, step 222 is a decision step. If the real-time check performed at step 220 indicates that the consumer cannot utilize his or her phone bill as a method of payment, a notation is made in database 104 indicating that the consumer is a declined phone order, as shown in step 224. Declined consumers are then presented with a page on which they are given the chance to complete their purchase using a credit card or other alternate form of payment. At step 226, if the real time check performed at step 220 indicates that the consumer is eligible to use his or her phone bill as a method of payment, a notation is made in database 104 indicating that the consumer is approved for phone bill payment. At step 228, if the consumer has been approved for phone bill payment, the consumer is presented with a page on which they are given the chance to instead complete the purchase using an alternative method of payment, such as a credit card.

Step 230 is the final decision step. If the consumer decides not to use a credit card or other alternate form of payment, the consumer is then categorized as a phone bill order. Once the consumer completes the order fields, the consumer is presented with a page that confirms the purchase and may also be configured to send the consumer a confirmation email. At step 234, if the consumer decides to use the alternate form of payment such as a credit card, the consumer is designated in database 104 as a credit card order (or other appropriate category) and thus not subject to phone billing. The consumer is then presented with a confirmation page as well as an email confirmation confirming the transaction and the alternative billing option.

In one exemplary embodiment, once the consumer has been presented with the credit card billing page and has entered his or her credit card number, billing server 102 checks the entered credit card number against a Bank Identification Number (BIN) database. A Bank Identification Number consists of a predetermined number of digits shown on the front of a credit card or other payment card, for example, the first six digits. The BIN is used to identify the party who issued the card to the consumer. Checking the consumer's entered credit card number with the BIN database allows the merchant to determine whether the card is legitimate, thus helping to prevent fraud. In one exemplary embodiment, the BIN database is a local database integrated with database 104. In another exemplary embodiment, billing server 102 may access the BIN database through network 112.

If billing server 102 cannot verify that the entered credit card number is legitimate based on a comparison with the data in the BIN database, the consumer may be recategorized as a phone bill order. The consumer may then be presented with a phone billing page along with an indication that the credit card could not be verified. In one exemplary embodiment, credit card billing page may change dynamically to a phone billing page once billing server 102 has determined that the entered credit card number may not be legitimate or trustworthy. Once the consumer completes the phone billing order fields, the consumer is presented with a page that confirms the purchase and may also be sent a confirmation email.

If billing server 102 determines that the consumer is not eligible for either phone billing—based on a check with phone billing consolidator 110, or credit card billing—based on a check with the BIN database, the consumer's previously entered information is saved in database 104 and may be used to raise potential flags for future transactions or to remarket to the consumer at a later time.

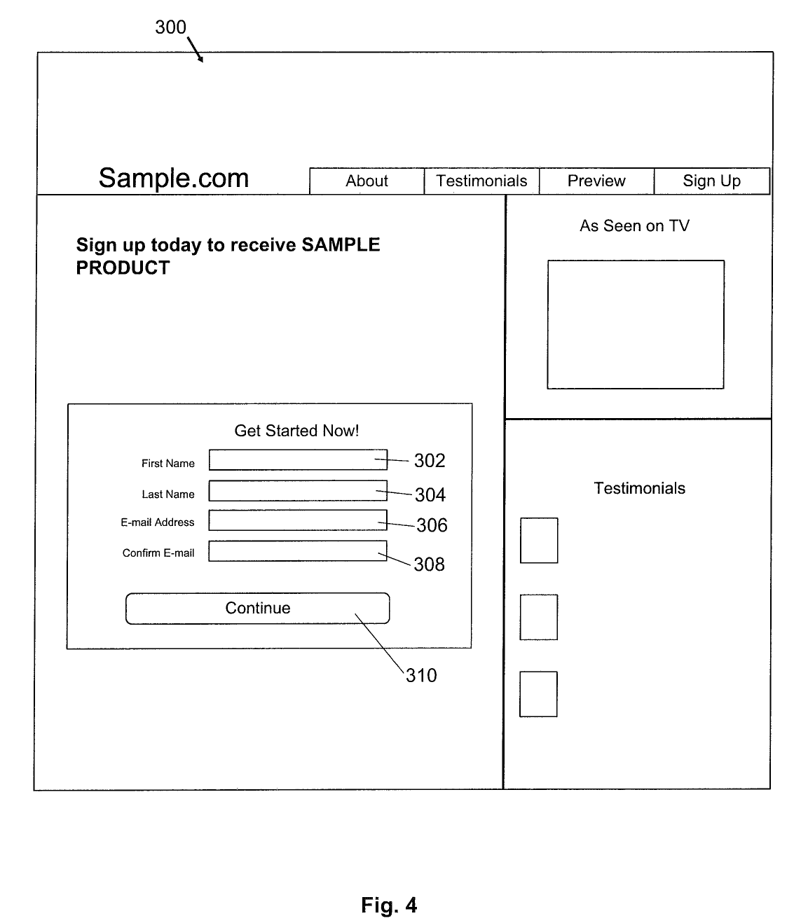

FIGS. 4-10 illustrate exemplary embodiments of pages that may be presented to the consumer by a web browser during the ordering process described above with respect to FIGS. 2 and 3. FIG. 4 illustrates an example of a first-level information or landing page 300, which may be the first page a consumer sees after deciding to make a purchase, for example, after clicking a checkout option within an electronic shopping cart application. Landing page 300 includes a plurality of text fields that allow the consumer to enter his or her first level information. As shown in FIG. 4, landing page 300 may include a First Name field 302, a Last Name field 304, and an email address field 306. Landing page 300 may also include a confirmation field 308, to ensure that the entered email address is accurate, and a Continue button 310.

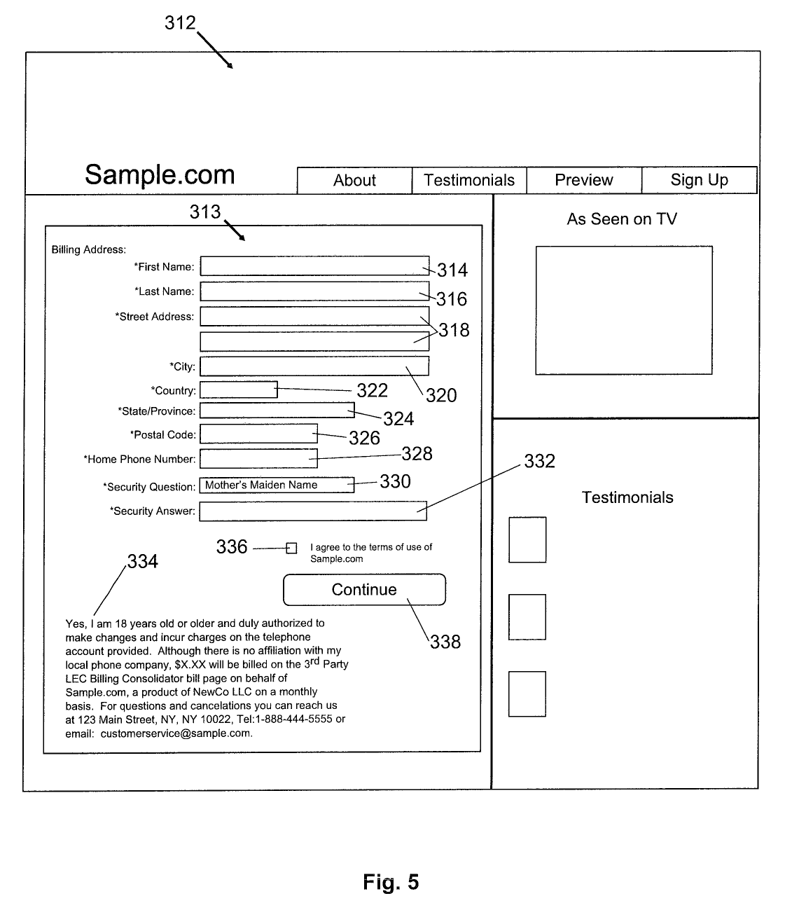

FIG. 5 illustrates a second level information page 312. The consumer will be presented with second level information page 312 after completing the fields in landing page 300 and selecting the Continue button 310. Second level information page 312 may include a billing address window 313 displaying a plurality of text fields that allow the consumer to enter second level information. As shown in FIG. 5, billing address window 313 may include a First Name field 314, a Last Name field 316, Street Address fields 318, a City field 320, a Country field 322, a State/Province field 324, a Postal Code field 326, a Phone Number field 328, a Security Question field 330, and a Security Answer field 332. Preferably, when the consumer is presented with second level information page 312, the information entered into landing page 300, such as the consumer's name, is automatically populated into the relevant fields shown in second level information page 312.

Second level information page 312 may also include terms of use language 334 relating to third-party billing through a local exchange carrier, as well as a checkbox 336 allowing the consumer to consent to the terms of use. Second level information page 312 may also include a Continue button 338. In one exemplary embodiment, system 100 does not send a request to billing server 102 to check whether the consumer's phone number is eligible for phone billing until the customer selects Continue button 338. In another exemplary embodiment, the request is sent to billing server 102 as soon as the phone number is entered into Phone Number field 328.

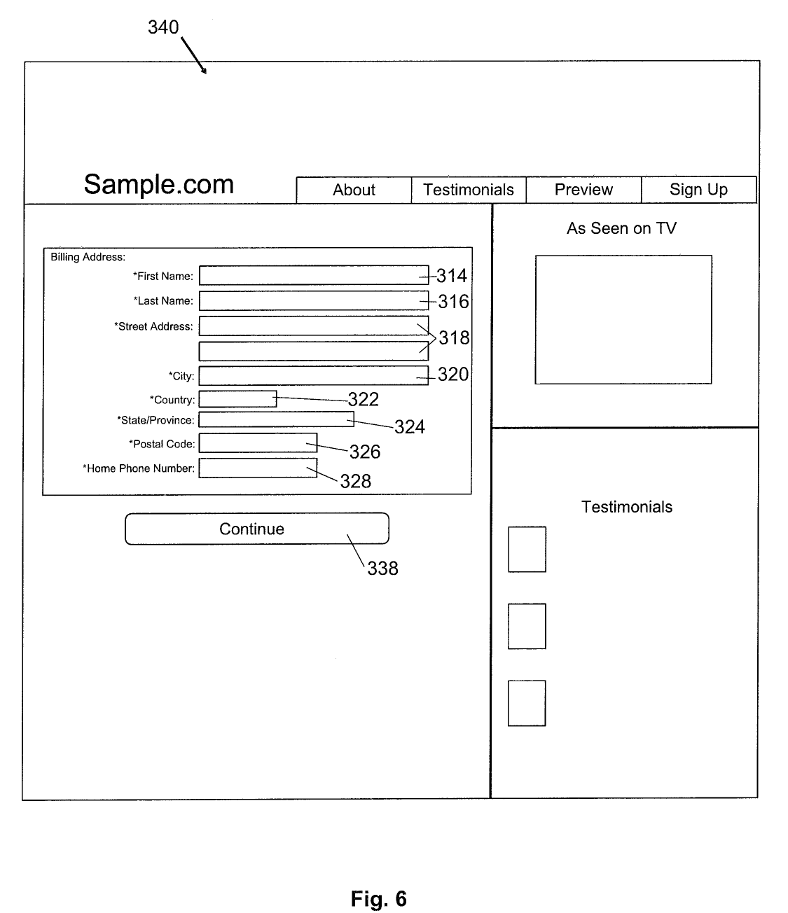

FIG. 6 illustrates an exemplary embodiment of a modified second level information page 340 shown to the consumer when billing server 102 determines that the consumer's phone number is not eligible for third-party local exchange carrier billing. In this case, second level information page 340 remains the same as shown in FIG. 5, except that the Security Question field 330, Security Answer field 332, terms of use language 334 and checkbox 336 are no longer visible. Using asynchronous technology, these portions of the page are removed without refreshing the rest of second level information page 312. Any data entered by the consumer into First Name field 314, Last Name field 316, Street Address fields 318, City field 320, Country field 322, State/Province field 324, Postal Code field 326, and Phone Number field 328 still remains visible within the respective text fields. In other words, the request from the web browser to billing server 102 to check whether the consumer's phone number is billable is a seamless process that occurs in the background without any input from the consumer. If the number is not billable, second level information page 312 dynamically changes to modified second level information page 340 by removing the information that is no longer relevant.

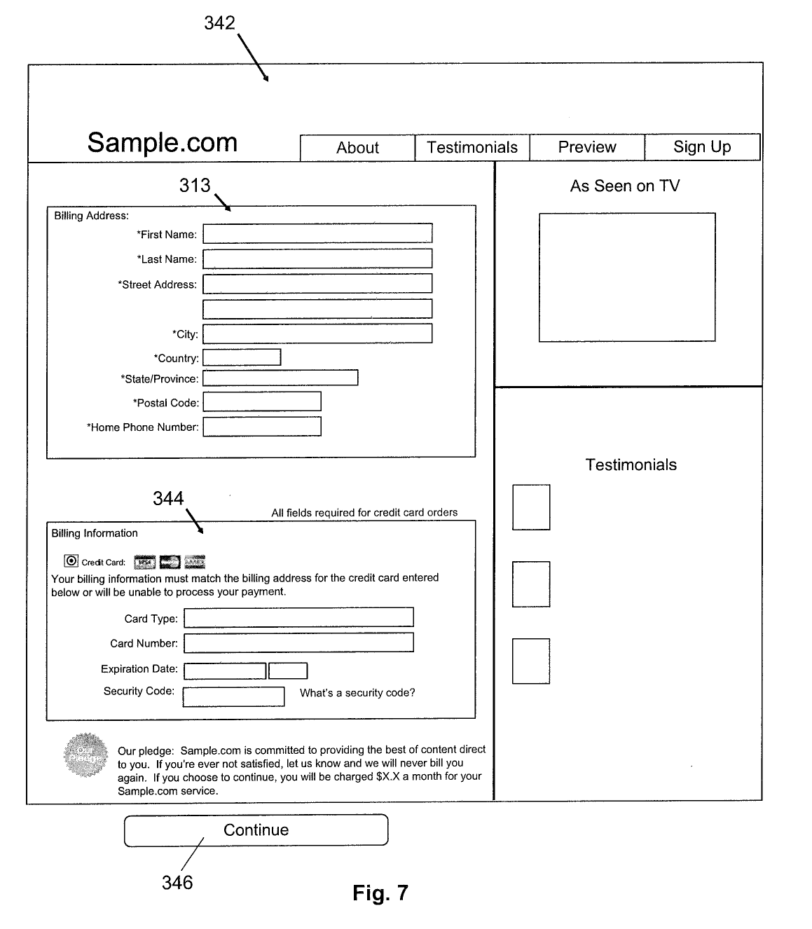

FIG. 7 illustrates an exemplary embodiment of a credit card billing page 342. The consumer may be presented with credit card billing page 342 after clicking the Continue button 338 on second level information page 312 or modified second level information page 340. To encourage consumers to use credit card billing (or other alternate billing methods that are similarly priced for a merchant), credit card billing page 342 will be shown to the consumer regardless of the consumer's eligibility for third-party local exchange carrier billing. In one exemplary embodiment, credit card billing page 342 displays billing address window 313, with the information entered previously by the consumer, and a billing information window 344 with a plurality of text fields for entering the consumer's credit card information.

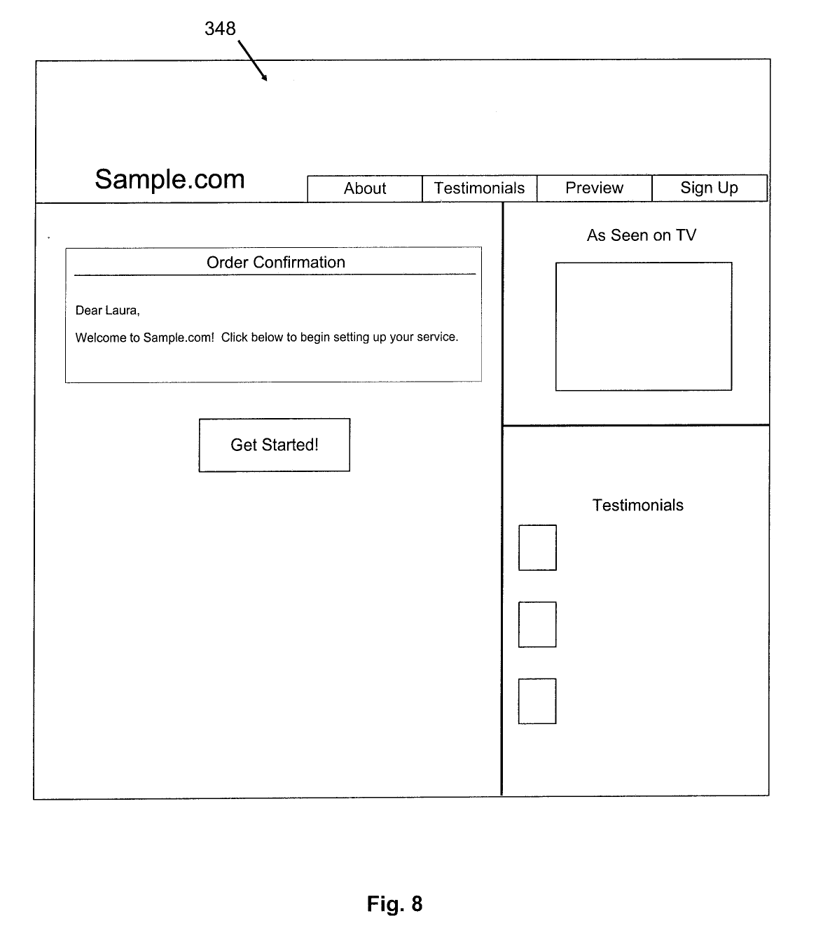

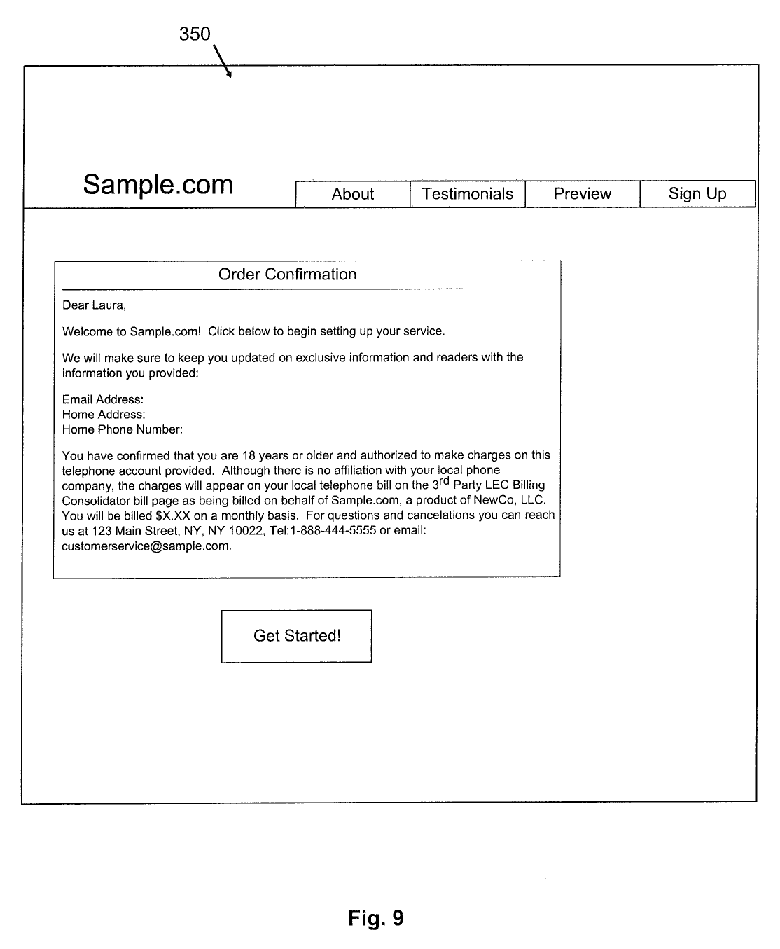

In one exemplary embodiment, credit card billing page 342 is generated dynamically using asynchronous technology. For example, billing address window 313 may remain on the page and billing information window 344 may dynamically appear without input from the consumer. In another exemplary embodiment, credit card billing page 342 may be a new page. Credit card billing page 342 may also include a Continue button 346. If the consumer enters his or her credit card information into billing information window 344 before clicking Continue button 346, the consumer will be taken to a credit card order confirmation page 348, as shown in FIG. 8. On the other hand, if the consumer clicks Continue button 346 without entering his or her credit card information into billing window 344, the consumer will be taken to a phone billing confirmation page 350, as shown in FIG. 9, provided that the consumer's phone number is eligible for third-party local exchange carrier billing. If the consumer is not eligible for third-party local exchange carrier billing, the consumer may be prompted to either enter suitable payment information or to terminate the transaction.

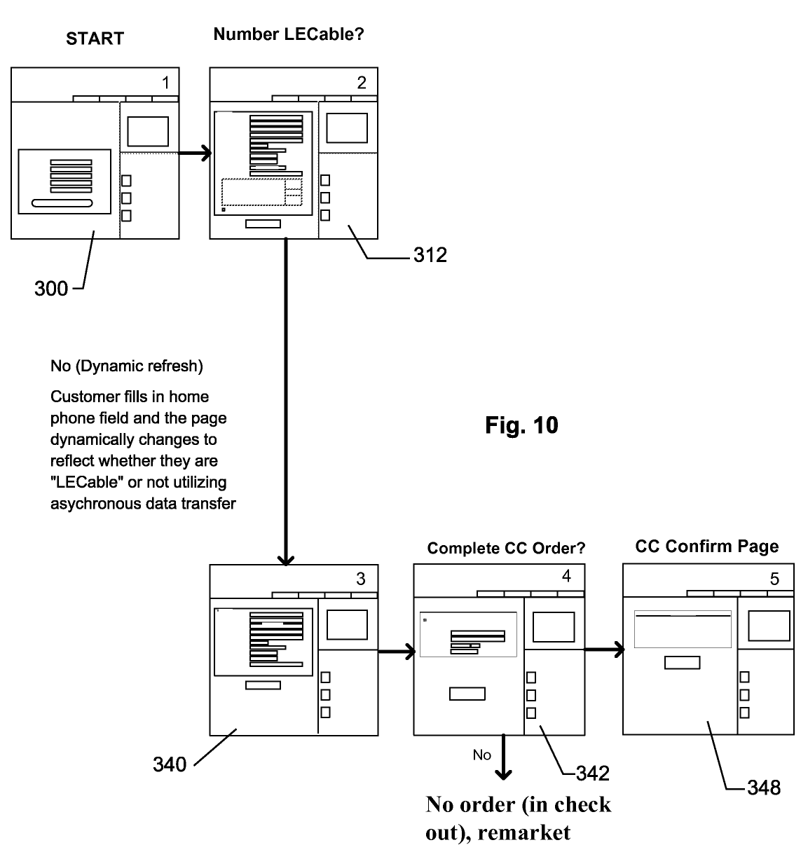

FIGS. 10-13 illustrate the process for optimizing an online order, showing exemplary paths that may be taken and exemplary pages that may be rendered by the web browser, including landing page 300, second level information page 312, alternate second level information page 340 credit card billing page 342, credit card confirmation page 348, and phone billing confirmation page 350.

FIG. 10 illustrates the flow of the order process when a consumer enters a phone number that is not eligible to be billed through a local exchange carrier. The consumer begins on landing page 300, where he enters his first level information, including his name and email address, which is saved to database 104. The consumer is then taken to second level information page 312, where he enters his second level information, including his address and phone number. Once he has entered his phone number, the web browser sends a request to billing server 102 and determines that the consumer is not eligible for phone billing. Second level information page 312 is then dynamically and automatically changed to modified second level information page 340, which does not include the terms of use language for phone billing. The consumer is then taken to credit card billing page 342. If he enters his credit card information and clicks continue, the order is completed and he is shown credit card confirmation page 348. If he fails to enter his credit card information, the consumer's previously entered information is saved in database 104 and may be used to remarket the consumer at a later time.

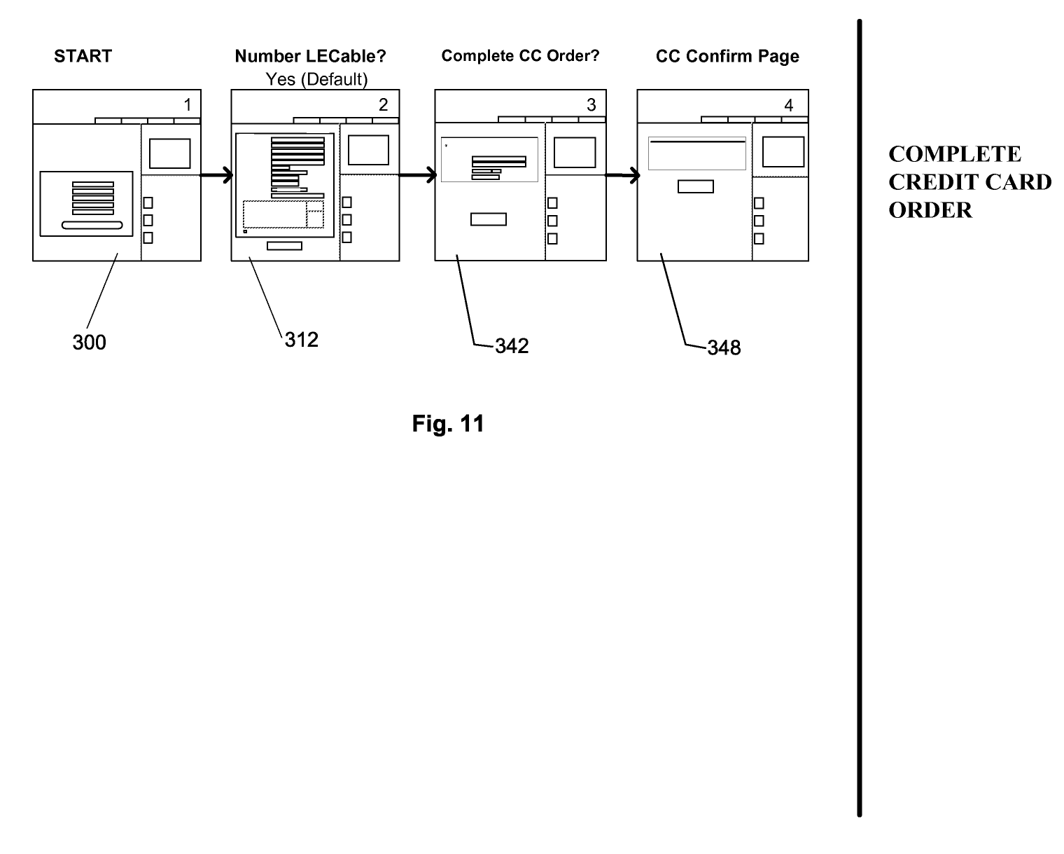

FIG. 11 illustrates the flow of the order process when a consumer enters a phone number that is eligible to be billed through a local exchange carrier, but elects to pay by credit card. The consumer begins on landing page 300, where she enters her first level information, including her name and email address, which is saved to database 104. The consumer is then taken to second level information page 312, where she enters her second level information, including her address and phone number. Once she has entered her phone number, the web browser sends a request to billing server 102 and determines that the consumer is eligible for phone billing. Second level information page 312 remains the same, allowing the consumer to agree to the terms of use for phone billing. However, the consumer is still taken to credit card billing page 342 to encourage her to use a payment option that is less costly for the merchant. Once the consumer has entered her credit card information and selected a continue button, the order is completed and she is shown credit card confirmation page 348.

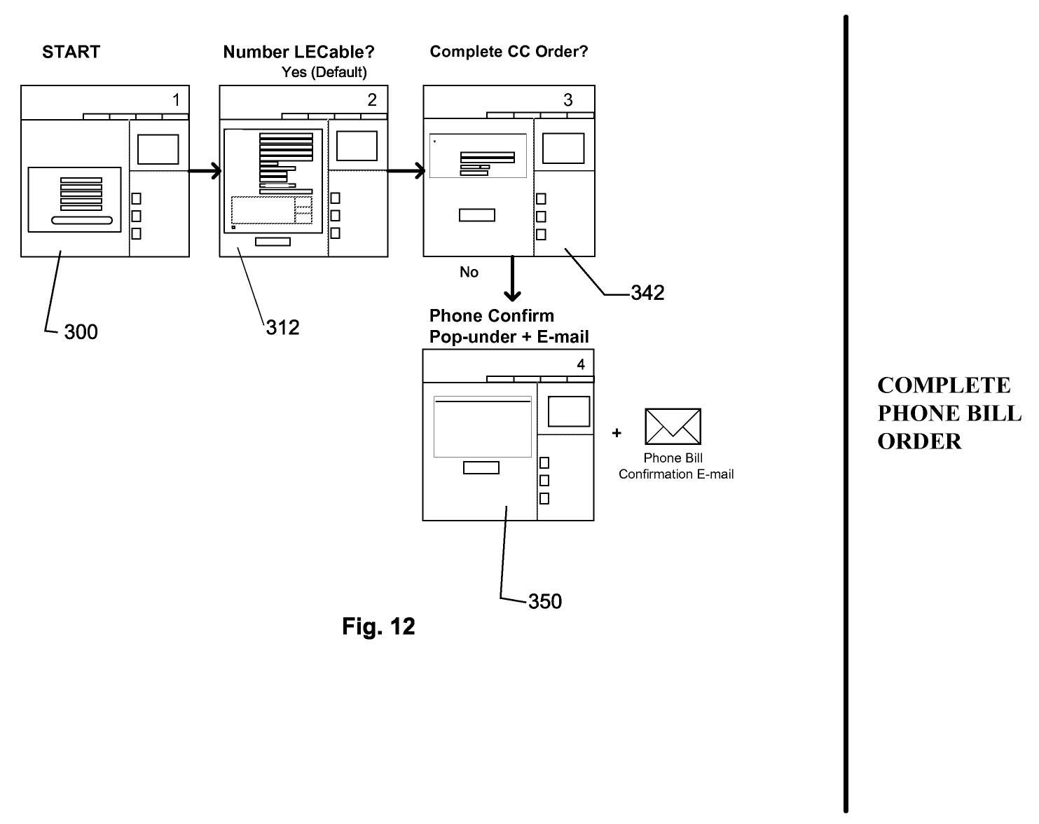

FIG. 12 illustrates the flow of the order process when a consumer enters a phone number that is eligible to be billed through a local exchange carrier and where the consumer chooses this billing option. The consumer begins on landing page 300, where she enters her first level information, including her name and email address, which is saved to database 104. The consumer is then taken to second level information page 312, where she enters her second level information, including her address and phone number. Once she has entered her phone number, the web browser sends a request to billing server 102 and determines that she is eligible for phone billing. Second level information page 312 remains the same, allowing the consumer to agree to the terms of use for phone billing. When the consumer agrees to the terms of use by clicking checkbox 336 in second level information page 312, the consumer is still taken to credit card billing page 342 to encourage her to use a payment option that is less costly for the merchant. If the consumer does not enter her credit card information and clicks Continue button 346 on credit card billing page 342, the order is completed and will be billed through the consumer's local exchange carrier. The consumer will then be shown phone billing confirmation page 350. The charge for the transaction will then show up on the consumers local phone bill; she may also receive a confirmation email.

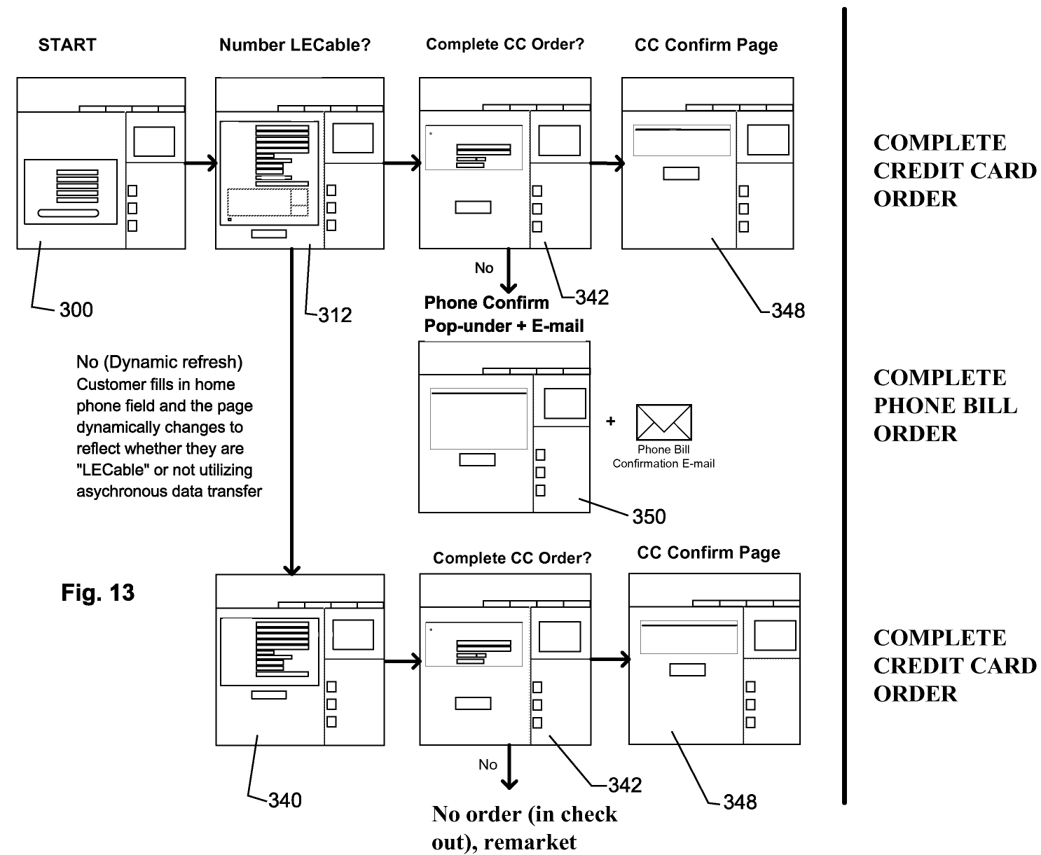

FIG. 13 illustrates the process flows shown in FIGS. 10-12 in a single diagram. As shown, the consumer may complete the transaction using a credit card (or other similarly priced payment type), even when he or she is eligible for phone billing; the consumer may complete the transaction using a credit card when he or she is not eligible for phone billing; and finally, the consumer may opt for phone billing rather than paying with a credit card.

The present invention, as described above and shown in the drawings, provides for improved methods and systems for optimizing process flow of an online order to maximize efficiency while minimizing costs. It will be apparent to those skilled in the art that various modifications can be made to the systems and methods of the present invention without departing from the scope of the invention as outlined in the appended claims and their equivalents.

1. A computer-implemented method for optimizing process flow of an online order, the method comprising:
providing a client device displaying a user interface;
presenting a consumer with an information page in the user interface requesting a set of first level information, including the phone number of the consumer;
receiving first level information from the consumer through the user interface;
using a server interfacing with a database to determine whether the phone number is eligible for third party local exchange carrier billing;
when the phone number is eligible for third-party local exchange carrier billing, presenting the consumer with a credit card billing page and then a phone billing page if no credit card information is received from the consumer; and
when the phone number is not eligible for third-party local exchange carrier billing, presenting the consumer with a credit card billing page.

2. The method of claim 1, wherein the step of presenting a consumer with an information page in the user interface further comprises dynamically changing the content of the information page depending on whether the consumer is eligible for third-party local exchange carrier billing.

3. The method of claim 1, wherein the step of presenting a consumer with an information page in the user interface includes the steps of presenting a first information page requesting the consumer's name and email address, and presenting a second information page requesting the consumer's address and phone number.

4. The method of claim 1, further comprising presenting the consumer with a confirmation page.

5. The method of claim 1, wherein the step of determining whether the phone number is eligible for third-party local exchange carrier billing includes first determining eligibility of the phone number at a block level.

6. The method of claim 5, wherein the step of determining whether the phone number is eligible for third-party local exchange carrier billing includes determining eligibility of the phone number at the individual consumer level.

7. A system for optimizing process flow of an online order, the system comprising:
a server having a processor and a memory;
a database interfacing with the server;
a client device interfacing with the server and displaying a user interface;
wherein the user interface includes an information page configured to request a set of first level information, including the phone number of the consumer;
wherein the server is configured to determine whether the phone number is eligible for third party local exchange carrier billing;
wherein the server is further configured to present the consumer with a credit card billing page and then a phone billing page if no credit card information is received from the consumer when the phone number is eligible for third-party local exchange carrier billing; and
wherein the server is further configured to present the consumer with a credit card billing page when the phone number is not eligible for third-party local exchange carrier billing.

8. The system of claim 7, wherein the server is further configured to dynamically change the content of the information page depending on whether the consumer is eligible for third-party local exchange carrier billing.

9. The system of claim 7, wherein the server is further configured to present a first information page requesting the consumer's name and email address, and to present a second information page requesting the consumer's address and phone number.

10. The system of claim 7, wherein the server is further configured to present the consumer with a confirmation page and a confirmation email.

11. The system of claim 7, wherein the server is further configured to determine the eligibility for third-party local exchange carrier billing by first determining eligibility of the phone number at a block level.

12. The system of claim 11, wherein the server is further configured to determine the eligibility for third-party local exchange carrier billing by next determining eligibility of the phone number at the individual consumer level.
